(19) United States
(12) Patent Application Publication
(10) Pub. No.: US 2007/0240329 A1
(43) Pub. Date: Oct. 18, 2007

(54) System and Method for Manually Drying an Article of Clothing

(76) Inventor: Scot H. Weiss, Orlando, FL (US)

Correspondence Address: Terry M. Sanks;Beusse Wolter Sanks Mora & Maire, P.A., Suite 2500, 390 North Orange Avenue, Orlando, FL, 32801, US

(21) Appl. No.: 11/736,953

(22) Filed: Apr. 18, 2007

Related U.S. Application Data
(60) Provisional application No. 60/792,848, filed on Apr. 18, 2006.

(51) Int. Cl. F26B 5/08; F26B 11/02

(52) U.S. Cl. 34/312; 34/601

(57) ABSTRACT

A manually operated clothes drying system including at least one outer container configured to hold a liquid, at least one inner container located within the at least one outer container and elevated above a floor of the at least one outer container, a plurality of openings disposed therethrough a wall forming at least one of the inner container, a gearbox system connected to the at least one inner container configured to rotate the at least one inner container about a center axis, a lid configured to cover a top opening of at least one of the at least one inner container and the at least one outer container, and means configured for continuous manual interaction to operate the gearbox system to result in rotation of the at least one inner container at a high rate of rotation.

### CROSS-REFERENCE TO RELATED APPLICATIONS

The present application is based on U.S. Provisional Application No. 60/792,848 filed Apr. 18, 2006.

### FIELD OF INVENTION

The present invention relates to a clothes drying apparatus and, more particularly, to a system and method for drying an article of clothing manually.

### BACKGROUND OF THE INVENTION

Traditional clothes dryers have a rotating tumbler that holds the clothes. An electric or gas powered heater is also provided that heats the air that is drawn through the clothes as they tumble, which in turn heats up the clothes and the water in them. An exhaust vent is also part of the dryer that passes out of the dryer. This is how the water exits the dryer in the form of steam. Operating such dryers involves financial cost associated with electricity and/or gas that must be purchased. Towards this end, it is usually more cost effective to dry more than one article of clothing at a time.

However, situations arise where needs for a clothes dryer arise where traditional clothes dryers are not as practical. For example if at a public swimming pool, a swimmer may desire to dry a swimsuit prior to returning it to a gym bag. Because of the costs associated, the operators of the public pool may not make traditional clothes dryers available. Furthermore because of the time associated with drying, including time for the heating element to begin producing optimum heat, or nearly drying an article of clothing, the swimmer may not want to wait for the suit to be dried or nearly dried.

Thus, a need exists for a drying apparatus that may be used to dry a limited number of clothing articles while also not requiring electricity and/or gas to complete the drying or near-drying process. Additionally a need sometimes arises to first treat a clothing article prior to drying it so as to remove other chemicals from the article.

### BRIEF DESCRIPTION OF THE INVENTION

Exemplary embodiments of the invention disclose a system and method for drying an article of clothing manually. Towards this end a manually operated clothes drying system is disclosed. The system includes at least one outer container configured to hold a liquid, and at least one inner container located within the at least one outer container and elevated above a floor of the at least one outer container. A plurality of openings is disposed which are formed therethrough a wall that forms the at least inner container. A gearbox system is also disclosed connected to the at least one inner container configured to rotate the at least one inner container about a center axis. A lid that is configured to cover a top opening of at least one of the at least one inner container and the at least one outer container is also provided. A means is provided that is configured for continuous manual interaction to operate the gearbox system to result in rotation of the at least one inner container at a high rate of rotation.

In another exemplary embodiment a method for manually drying at least one article of clothing is disclosed. The method includes a step for placing the at least one article of clothing within an inner container having a plurality of perforations formed therethrough the inner container through which liquid removed from the at least one article of clothing passes. A step for continuously manually controlling a means that causes the inner container to rotate at a high rate of rotation is also provided. Another step includes passing the liquid therethrough the plurality of perforations as a result of the high rate of rotation. Another step involves collecting the liquid that has passed therethrough the plurality of perforations within an outer container.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, exemplary embodiments of the invention will be described and explained with additional specificity and detail through the use of the accompanying drawings in which:

FIG. 1 depicts an exemplary embodiment of the manually operated dryer;

FIG. 2 depicts a frontal view of the manually operated dryer with the upper cover and lower cover removed;

FIG. 3 depicts an exemplary embodiment of the gearbox mechanism;

FIG. 4 depicts an underside of an exemplary gearbox mechanism;

FIG. 5 depicts a braking system prohibiting the cranks from operating;

FIG. 6 depicts of a top view of the manually operated dryer having a plurality of inner containers; and

FIG. 7 depicts a flowchart illustrating exemplary steps.

### DETAILED DESCRIPTION OF THE INVENTION

Reference will now be made in detail to the embodiments consistent with the invention, examples of which are illustrated in the accompanying drawings. The present invention solves problems in the art by providing an apparatus that allows for a portable hand-operated drying apparatus for such garments as swimsuits.

Though exemplary embodiments of the present invention are described with respect to a clothes dryer, those skilled in the art will recognize that exemplary embodiments are applicable to other drying and/or cleaning-type devices as well. The present invention solves problems in the art by providing a system and method that allows for manually drying or nearly drying an article of clothing wherein the device is more compact than a traditional clothes dryer

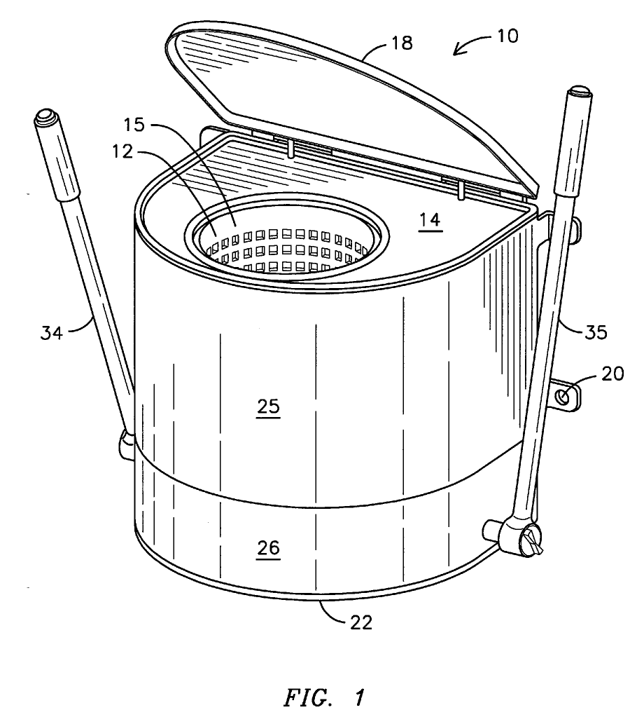

FIG. 1 depicts an exemplary embodiment of the manually operated dryer. Within the manually operated dryer 10, an inner container 12 into which an article of clothing may be placed is illustrated. A support top 14 is provided around the top lip 15 of the inner container 12. A lid 18 that may be lifted is also included. A connection element 20, or fixation point, is provided for attaching the dryer 10 to a wall or another surface. For example, though the connection element 20 is shown where connection may be is made to a vertical surface, the connection element 20 may also be located at a base 22 of the dryer 10 so that it is used to connect the dryer 10 to a horizontal surface. As illustrated, and though a single outer cover may be provided, an upper outer cover 25 and a lower outer cover 26 are disclosed. The lower outer cover 26 encloses a gear box system 30 that is discussed in more detail below. The upper outer cover 25 encloses an area or cavity 32 surrounding the inner container 12. A first crank 34 and a second crank 35 are also disclosed. Though two cranks are illustrated, those skilled in the art will recognize that only one crank may be utilized or other mechanisms as disclosed within may be used. A brake system 13, discussed in further detail herein, is also disclosed.

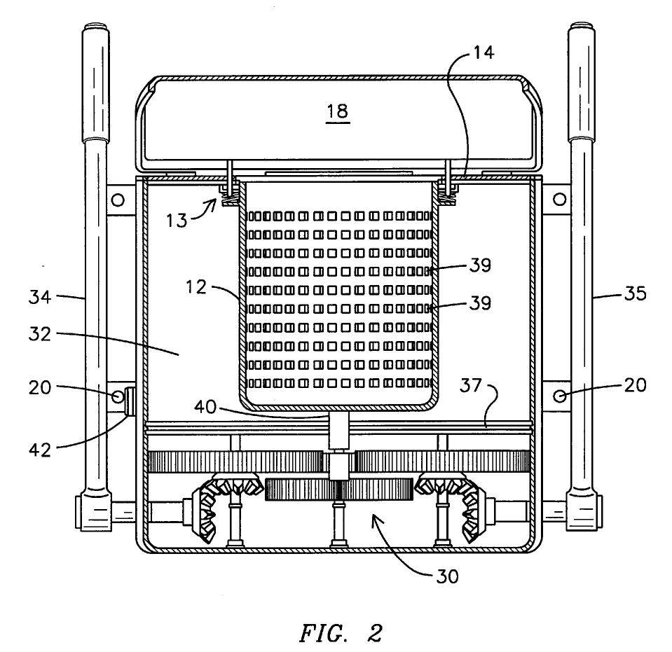

FIG. 2 depicts a frontal view of the manually operated dryer with the upper cover and lower cover removed. As illustrated, the gear box system 30 is located beneath the inner container 12 and is separated by a wall 37. A cavity 32 is formed above the gear box system 30 where the inner container 72 is displaced. The inner container 12 includes a wall having a plurality of openings 39, holes or perforations, through which water may pass. The inner container 12 is situated so as to be able to rotate about a center axis 40. Water passing through the openings 39 may collect in the cavity 32. A drain opening 42 is provided near the bottom of the cavity 32 to provide a location where water accumulated may be removed. In an exemplary embodiment, a hose is attached to allow continual removal of water or other liquids.

A means to manually rotate the inner body is provided. In an exemplary embodiment, this is accomplished with a crank 34, 35 as disclosed, lever, and/or button (which is pushed a plurality of times), which may be connected to a gearbox system 30. The crank 34, 35 is connected to a plurality of gears 30 that create the rotation of the inner container 12. In an exemplary embodiment, the gear ratio is at a high enough degree so that the inner container 12 turns at faster rate than the motion of the hand crank 34, 35.

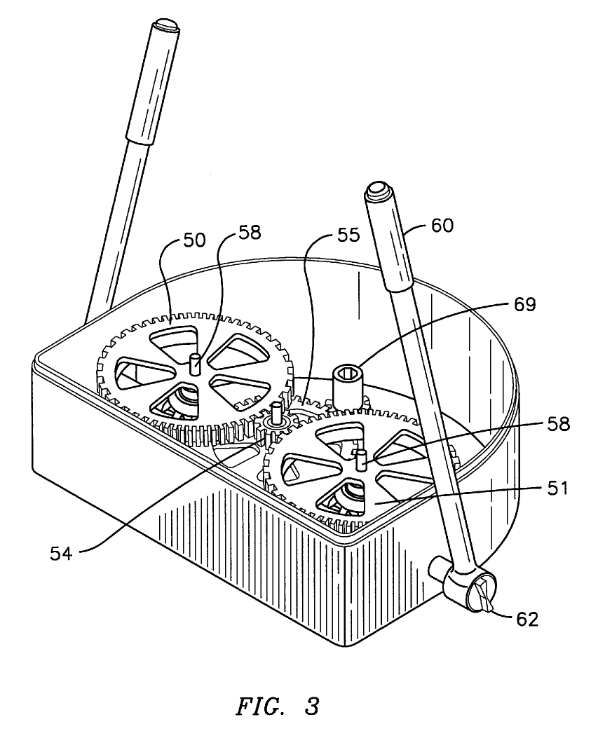

FIG. 3 depicts an exemplary embodiment of the gearbox mechanism. As illustrated two large gears 50, 51 engage a smaller gear 54 that is part of a medium gear 55 beneath the two large gears 50, 51. The smaller gear 54 has an attachment point 58 that is used to assist in holding the gearbox mechanism in place while in motion. Similar points 58 are also provided on the large gears 50, 51. The cranks 34, 35 are used to move the gears, which in turn results in the inner container 12 to rotate. The cranks 34, 35 have handles 60 disposed on each crank 34, 35 for a user to grip. The cranks 34, 35 are of a sufficient length, such as but not limited to approximately seventeen inches, to deliver sufficient torque to rotate a high gear ratio. The gear ratio is approximately 1 to 21. Though this gear ratio is disclosed, those skilled in the art will readily recognize that a gear ratio slightly lower will also work as well as gear ratios above this approximation. By moving the cranks 34, 35 forward and backward, the inner container 12 may complete a single revolution a rate which is at approximately 2100 revolutions per minute. While this rate is disclosed, those skilled in the art will recognize that a rate lower may also provide the same result though taking longer to dry an article of clothing. Likewise, a higher rate is also preferable. Therefore, the faster the user pulls the handles 60 the faster the inner container 12 spins wherein the effort of pulling becomes easier as the rotational speed increases since the inner container 12 is providing less resistance.

In an exemplary embodiment, once the handle 60 has been pulled in a desired direction, to reduce a chance of injury from the moving cranks, the gearbox is mechanized so that the handle is released from an internal gear and then reengages the internal gear once moved back to a starting position. A one-way switch 62 may be provided to determine direction.

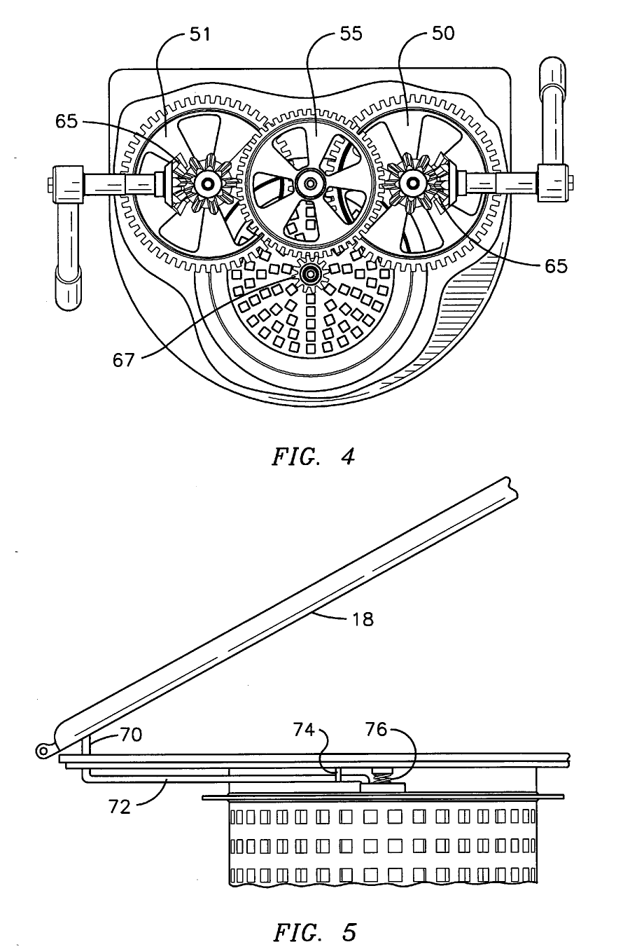

FIG. 4 depicts an underside of an exemplary gearbox mechanism. The larger gears 50, 51 have a gear system 65 that connects each respective gear 65 to a respective crank handle 34, 35. The medium gear 55 engages an inner container gear 67 that has a connector 69 that attaches to the inner container 12. Therefore as the inner container gear 67 turns so does the inner container 12.

In operation, the lid 18 is raised and an article of clothing, such as but not limited to a swimsuit, is placed within the inner container 12. The lid 18 is then closed and secured. In an exemplary embodiment, the cranks 34, 35 will not operate until the lid 18 is in a secured, or closed, position. FIG. 5 illustrates a braking system prohibiting the cranks from operating. As illustrated a latch is provided. A rod 72 extends from the latch through a pivot 74 to a spring-loaded stopper 76. When the lid 18 is up, the latch 70, pivot 74, and rod 72 function to result in the stopper 76 engaging the inner container 12 prohibiting the container 12 from rotating which in turn prohibits the cranks 34, 35 from moving. When the lid 18 is closed, the same elements 70, 72, 74 results in the stopper 76 being removed from the inner container 12 and the user may then operate the cranks 34, 35, creating the rotation of the inner container 12. The centrifugal force created by the spinning extracts water from the swimsuit. The water passes through the perforations 39 within the wall of the inner container 12 and comes to rest in the cavity.

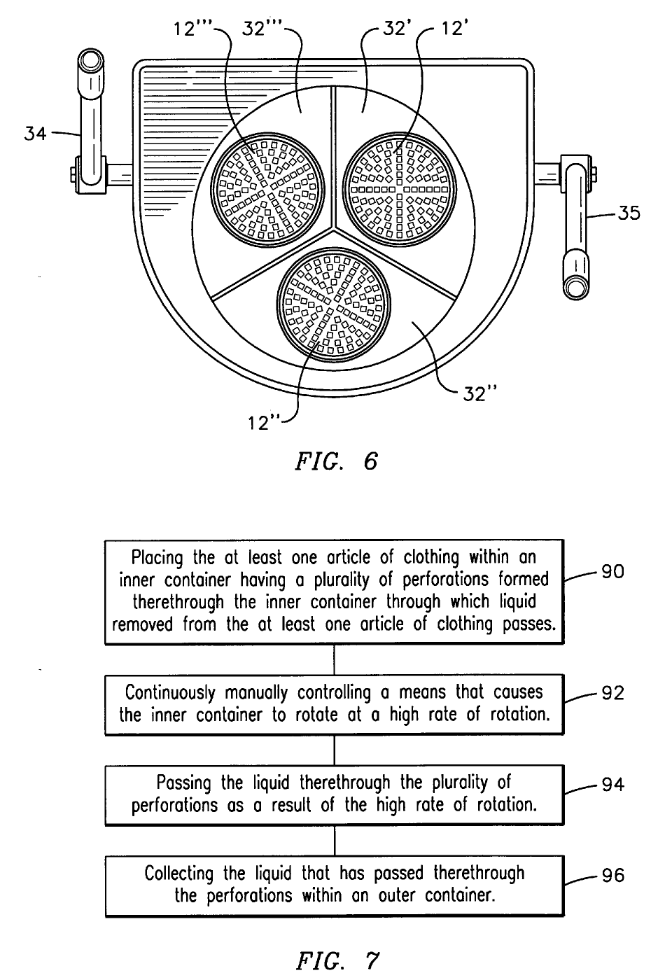

In another exemplary embodiment, illustrated in FIG. 6 instead of a single inner container 12 and a single cavity 32 into which the article of clothing is placed, a plurality of containers 12′, 12″, 12″′ are provided. Though a single cavity 32 may be used, an individual cavity 32′, 32″, 32″′ for each container 12′, 12″, 12″′ may also be provided, which is illustrated. A first container 12′ may contain a chlorine neutralizer. A second container 12″ may be a rinse tank and the third container 12″′ a drying tank. In this embodiment, the neutralizer container 12′ and the rinse container 12″ do not have permanent perforations 39. Instead, after so many revolutions, covers (not illustrated) over the perforations are opened, either manually or automatically, to allow the rinse liquid and/or chlorine neutralizer to pass out of the respective container 12′, 12″ into the cavity 32 or specific respective cavity 32′, 32″. The cover may be an outer cover that encloses the outer wall of the inner container, having a perforation pattern so that when rotated a certain degree, closes the perforations within the wall of the inner container. In another exemplary embodiment, the second wall may be located within the inner container. A secondary gearing system may be utilized to control the rotation of this second wall to perform its function of opening and closing the perforations formed therethrough the inner container. For automatic operation of the covers over the perforations, a counting device may be used to count a number of rotations.

In another exemplary embodiment these containers 12′, 12″ are removable from the manual dryer 10 so that the user may dispose of the liquids therein and then return the containers to the manual dryer 10. After each cycle is completed, which is based on a predetermined number of times to activate the cranks 34, 35, the user opens the lid 18 and places the garment into the next cylinder 12″, 12″′. Those skilled in the art will readily recognize that the gear box mechanism 30 may be configured to insure rotation of the containers 12′, 12″, 12″′ at a high enough rate as disclosed herein. Additionally, though three inner containers 12′, 12″, 12″′ are illustrated more or less than three may be used as well.

Exemplary embodiments of the present invention may be located at a plurality of locations. For example it may table based. In another exemplary embodiment the manual dryer 10 has legs and is self-standing. In another embodiment, the manual dryer 10 is small enough to be transportable by an individual. In other embodiments, an industrial and home version may be possible. These versions may fit within a basin or another device to provide a more ornamental appearance.

FIG. 7 depicts a flowchart illustrating exemplary steps. One step involves placing the at least one article of clothing within an inner container having a plurality of perforations formed therethrough the inner container through which liquid removed from the at least one article of clothing passes, step 90. Another step, step 92, discloses continuously manually controlling a means that causes the inner container to rotate at a high rate of rotation. The liquid is passed therethrough the plurality of perforations as a result of the high rate of rotation, step 94. The liquid that has passed therethrough the plurality of perforations is collected within an outer container, step 96.

While exemplary embodiment of the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A manually operated clothes drying system, the system comprising:
(a) at least one outer container configured to hold a liquid;
(b) at least one inner container located within the at least one outer container and elevated above a floor of the at least one outer container;
(c) a plurality of openings disposed therethrough a wall forming the at least one inner container;
(d) a gearbox system connected to the at least one inner container configured to rotate the at least one inner container about a center axis;
(e) a lid configured to cover a top opening of at least one of the at least one inner container and the at least one outer container; and
(f) means configured for continuous manual interaction to operate the gearbox system to result in rotation of the at least one inner container at a high rate of rotation.

2. The system according to claim 1, further comprises a break system to prohibit the at least one inner container from rotating when the lid is in an open configuration.

3. The system according to claim 1, wherein the gear ratio at least approximately 1 to 21.

4. The system according to claim 1, wherein the at least one inner container rotates at a rate of at least approximately 2100 revolutions per minute.

5. The system according to claim 1, wherein the rate of rotation of the at least one inner container is determined by a rate at which the means to operate the gearbox.

6. The system according to claim 1, the at least one inner container comprises three inner containers.

7. The system according to claim 6, wherein the three inner containers are located within a single outer container.

8. The system according to claim 6, wherein each one of the three inner containers are located within an individual outer container.

9. The system according to claim 6, wherein a first container is a neutralizer container and contains a neutralizing substance to neutralize a specific chemical.

10. The system according to claim 6, wherein a second container is a rinse container and contains a rinsing element.

11. The system according to claim 6, wherein the openings further comprises a wall system that is configured to open and close the openings at a scheduled interval.

12. The system according to claim 1, further comprising a drain system configured to remove liquid from the at least one outer container.

13. The system according to claim 1, wherein the at least one inner container is elevated at a specific height so that liquid collected within the at least one outer container does not flow therethrough at least one opening.

14. A method for manually drying at least one article of clothing, the method comprising:
(a) placing the at least one article of clothing within an inner container having a plurality of perforations formed therethrough the inner container through which liquid removed from the at least one article of clothing passes;
(b) continuously manually controlling a means that causes the inner container to rotate at a high rate of rotation;
(c) passing the liquid therethrough the plurality of perforations as a result of the high rate of rotation; and
(d) collecting the liquid that has passed therethrough the plurality of perforations within an outer container.

15. The method according to claim 14, further comprises placing the at least one article of clothing within a second inner container having a neutralizing substance to neutralize a substance within the at least one article of clothing.

16. The method according to claim 14, further comprises placing the at least one article of clothing within a third inner container having a rinsing substance.

17. The method according to claim 14, further comprises covering the inner container prior to causing it to rotate.

18. The method according to claim 17, further comprises prohibiting the step of continuously manually controlling a means that causes the inner container to rotate at a high rate of rotation to occur until the step of covering the inner container is performed.

19. The method according to claim 14, further comprises draining the liquid that is within the outer container.
